(19) United States
(12) Patent Application Publication
(10) Pub. No.: US 2002/0161635 A1
(43) Pub. Date: Oct. 31, 2002

(54) System for advertisement production and distribution

(75) Inventors: Mayer A. Berg, Eagen, MN (US); Robert C. Voss, Lakeville, MN (US); Brian J. Groschen, Pine City, MN (US)

Correspondence Address: SCHWEGMAN, LUNDBERG, WOESSNER & KLUTH, P.A., P.O. BOX 2938, MINNEAPOLIS, MN, 55402, US

(73) Assignee: FamilyClubUSA, Inc.

(21) Appl. No.: 09/934,311

(22) Filed: Aug. 21, 2001

Related U.S. Application Data
(60) Provisional application No. 60/286,635, filed on Apr. 26, 2001.

(51) Int. Cl. G06F 17/60

(52) U.S. Cl. 705/14

(57) ABSTRACT

A system for advertisement production and distribution which includes a specially made video which is distributed with a print piece to a number of target consumers. In one application, the target audience is selected from a database of consumers based on a life event. The specially made video is produced by grouping “partners” which may be offering goods or services to the target consumers. The video is distributed with a print piece that provides additional information and/or coupons related to the offers.

In one application, the video or the print piece may include instructions on how to enter a drawing or claim a prize. In one example, a code is provided which a prospective consumer can bring to a store and check to see if they have won a prize. In an alternate application, a website may be provided which will ask questions of the consumer and receive the code to determine if they won a prize.

In one aspect of the present system, a specially packaged video is provided which includes the video, the print piece, and a label which are integrally packaged for easy distribution to the target consumers. The video may be stored on a number of media, including, but not limited to magnetic tape, digital video disk, and compact disk. In one aspect of the present system, a merchant offer is modified based on information about a particular consumer. The modification can arise in the form of coupons printed or offered electronically.

Other uses of the system include, but are not limited to, packaging and distribution of books and audio tapes.

### FIELD OF THE INVENTION

The present invention relates generally to systems for advertising production and distribution.

### BACKGROUND

Most of the advertising material we receive each day is discarded without much consideration. Oftentimes, the advertising is discarded automatically. Even in cases when the advertising is considered, few consumers will actually purchase based on the advertised materials.

One reason people throw away advertising is that it is not directed to them in any way. For example, a person who does not have children may receive solicitations for day care or children's toys which they will never use. Such advertising is sometimes viewed as being offensive and annoying.

Another reason people throw away advertising is that the solicitation they receive is not timely. It could be months or years off. This material is discarded and infrequently results in a sale of goods or services.

Thus, there is a need in the art for a system for production and distribution of advertising which is more likely to be considered by being relevant and timely and produces a higher statistical probability of a sale of goods or services.

### SUMMARY

The present invention relates to a system for advertisement production and distribution which addresses the foregoing issues. In one embodiment, the system includes a specially made video which is distributed with a print piece to a number of target consumers. In this embodiment, the target audience is selected from a database of consumers based on a life event, such as an upcoming birthday or anniversary. The specially made video is produced by grouping “partners” which may be offering goods or services to the target consumers. The video is distributed with a print piece that provides additional information and/or coupons related to the offers.

In one embodiment, the video or the print piece may include instructions on how to enter a drawing or claim a prize. In one example, a code is provided which a prospective consumer can bring to a store and check to see if they have won a prize. In an alternate embodiment, a website may be provided which will ask questions of the consumer and receive the code to determine if they won a prize. In this way, the print piece works with the video to increase the probability of a sale, or at least gather some consumer information for future marketing efforts.

In one aspect of the present system, a specially packaged video is provided which includes the video, the print piece, and a label which are integrally packaged for easy distribution to the target consumers. The video may be stored on a number of media, including, but not limited to magnetic tape, digital video disk, and compact disk.

In one aspect of the present system, a merchant offer is modified based on information about a particular consumer. The modification can arise in the form of coupons printed or offered electronically.

This summary is intended to provide an overview of the subject matter of the present patent application. It is not intended to provide an exhaustive or exclusive explanation of the invention. The detailed description is included to provide further information about the subject matter of the present patent application.

### BRIEF DESCRIPTION OF THE FIGURES

FIG. 1 is a flowchart of one embodiment of the present system.

FIG. 2 is a flowchart showing how consumers respond to offers made by one embodiment of the present system.

FIG. 3 is a flowchart showing how consumer information is updated in the system according to one embodiment of the present system.

FIG. 4 demonstrates an example of a consumer database for use in one embodiment of the present system.

FIG. 5A illustrates a side view of one package with a video and print piece according to one embodiment of the present system.

FIG. 5B shows the package of FIG. 5A from a top view according to one embodiment of the present system.

FIG. 6A shows one example of a folded print piece according to one embodiment of the present system.

FIG. 6B shows the folding of the folded print piece of FIG. 6A according to one embodiment of the present system.

FIG. 7 shows a design for the package according to one embodiment of the present system.

FIG. 8 shows one example of a print piece according to one embodiment of the present system.

FIG. 9 shows the print piece of FIG. 8 laid flat.

FIG. 10 shows some examples of possible perforations of one or more pages of the print pieces according to one embodiment of the present system.

FIG. 11 shows one example of a print piece according to one embodiment of the present system.

FIG. 12 shows the print piece of FIG. 11 laid flat.

FIG. 13 shows a shrink wrapped version of the video and print piece according to one embodiment of the present system.

FIG. 14 shows a design for the package according to one embodiment of the present system.

### DETAILED DESCRIPTION

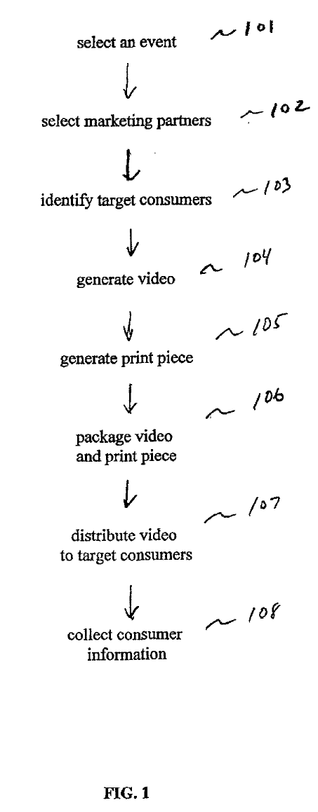

FIG. 1 is a flow chart showing how one embodiment of the present system is implemented. In this embodiment, an event is selected 101. In one example, the event is an upcoming birthday. In this example, the target consumers are all consumers that would purchase a birthday present for the person having the birthday. For example, the target audience could be parents, grandparents, and friends to the person having the birthday.

In another embodiment, the event is more narrowly defined, such as toddler birthdays. In that case the target audience is any individuals having a toddler or related to the toddler having an upcoming birthday. In one embodiment, the event is limited to a specific time frame so that solicitations are distributed in anticipation of the event. For example, the event could be toddlers having a birthday in the month of March. If solicitations are distributed by the second week of February, then all of the target consumers will be anticipating the event and have time to make a selection and take delivery of a good or service. Solicitations which are too early or too late are less likely to result in a purchase.

Once the event is known, the marketing “partners” are selected 102. This process includes the input of each interested partner and general agreement on how to proceed with the specialized solicitation. For example, in the toddler birthday examples, the number of partners may be 2, 3, 4, 5, 6, 7, 8, or any number which joins the efforts of the partners without providing too many options to the target consumers. The partners must also be carefully selected to avoid conflicts in marketing their goods or services. For example, if two partners sold the same stuffed toys, it is likely that the combination of the partners in single solicitation would cause a conflict.

The event selection and marketing partner selection help to identify the target consumers 103. For example, if the event is toddler birthdays and the ABC Company has decided to be a marketing partner in a particular solicitation, the target consumers can be identified from a customer list of the ABC Company or from any of the other partners.

Video

The marketing partners each have an offer to make in the joint solicitation of the target consumers. In one embodiment, the system includes a specially made video which provides information about each of the marketing partners and their offers 104. The joint presentation of the offers is preferably combined so that the target consumer who watches the video has a plurality of options for purchases related to the selected event. For example, if the event is a birthday party, then the offers may include a bakery with a sale on custom designed birthday cakes, an entertainment service which provides a clown for the party, and a party supply company which offers a sale on party cups, plates, and napkins.

The organization and format of each separate video offer can be coordinated to improve the likelihood of a purchase. In the birthday example, the cake, clown, and party supplies could be grouped as a package offer. The order of the offerings may be changed to cake, party supplies, and clown to provide the more common birthday party things (e.g., cake and party supplies) before the optional supplies (e.g., clown). The video may be specially tailored for the event and the particular target consumers.

In another embodiment the bulk of the information on the video will be pre-produced and have significant value for the recipient. For example, new mothers could receive a video on taking care of newborns. The information segment would be the bulk of the videotape, and each partner/sponsor would have a smaller (:15 to :30 second ad on the tape). Another example would be for a person who just moved into a home to receive information on attractions in that city. In such cases, the Company may license pre-produced material suitable for the targeted demographic. In some cases the Company might purchase the video material, or in other cases, might barter the material for space on the print portion of the direct mail piece to allow the producer of the video material to sell and promote additional products.

In another embodiment, the video would be produced to promote products and services by only one company, and the partner/sponsors would have only a :15 or :30 second advertising spot of the tape but would also be included in the print portion of the program. For example, a large electronics retailer would produce a tape promoting four types of products they would sell. Other non-competing products targeting the same demographic could be incorporated into the video and print portions of the direct mail video.

In another embodiment, the videotape will be used in the same way as a broadcast infomercial. One to six partners could have their own direct response segments produced on the video with a separate 1-800 number for each to call and order the product. A good example of this embodiment would be to send a direct mail video to targeted households of three to six year old children during the Christmas season. On the tape would be one to six products for three to six year old children that are non-competing. Each product would be demonstrated and sold on the tape and a 1-800 number would be called to order each product. The print portion of the piece would be used to promote additional features and benefits of the product, reinforce the 1-800 number, or possibly promote the individual companies web site.

In one embodiment, the video is stored on magnetic tape. In alternate embodiments, the video is stored on digital video disk or on compact disk formats. Other storage formats may be used without departing from the scope of the present system.

Upon reading and understanding the present disclosure, one skilled in the art will appreciate that several variations of the video and offers may be produced without departing from the scope of the present system.

Print Piece

In one embodiment, a print piece is generated to accompany the video 105. In one embodiment, the video is distributed with a print piece that provides additional information and/or coupons related to the offers. In one embodiment, the print piece provides instructions for making a purchase. The print piece may also include coupons or other redemption information. In one embodiment, the print piece provides a code which the prospective consumer can bring to a store to see if they have won a prize. The print piece may also inform the user how to enter a drawing. In one embodiment, the print piece includes a code which is entered into a web site to see if the prospective consumer has won a prize and/or what the prize won may be.

In one embodiment, the print piece is a four color, accordion folded document. In embodiments, where the print piece includes coupons, the edges may be perforated to provide easy tear-apart. In one embodiment, the coupons are dimensioned based on the video size. In one such embodiment, the coupons are 4″×7 ⅜″. Other designs and dimensions may be used without departing from the scope of the present system.

In one variation of the print piece, a one piece sheet having graphics on the first fold and coupons on following folds is folded into a flat layer. The one piece sheet uses attractive graphics and perforated coupons that provide multiple messages to a consumer opening the print piece. The outside graphics act as an attractive four color label that prompts the recipient to use the coupons and watch the video. The coupon sheet also takes the place of a four color videotape label thereby reducing the cost of the videotape portion of the program. In one embodiment the coupons are of any number. In another embodiment an odd number of coupons is provided to allow for less expensive one-sided printing.

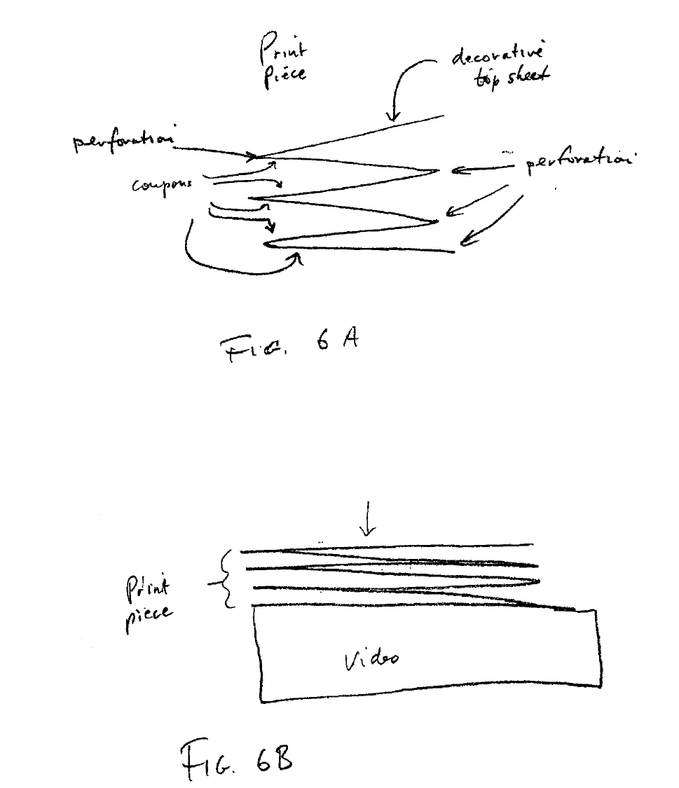

One example of the print piece is demonstrated in FIG. 6A, where an accordion folded document is shown with perforations. The decorative top sheet is an inexpensive cover for the video. The subsequent coupons may be printed on one or two sides. Perforations ease the assembly of the print piece and use of the coupons. The sheet is folded and placed on the video, as shown in FIG. 6B, prior to wrapping.

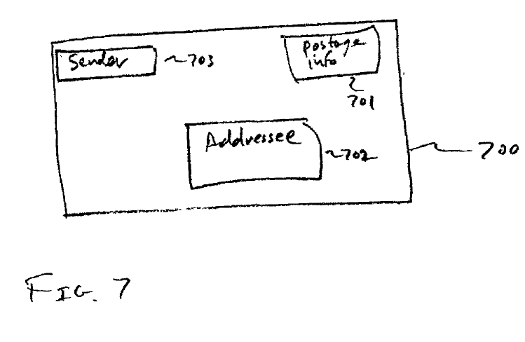

FIG. 7 shows one design of a label which provides postage information 701, addressee information 702, and return address information 703.

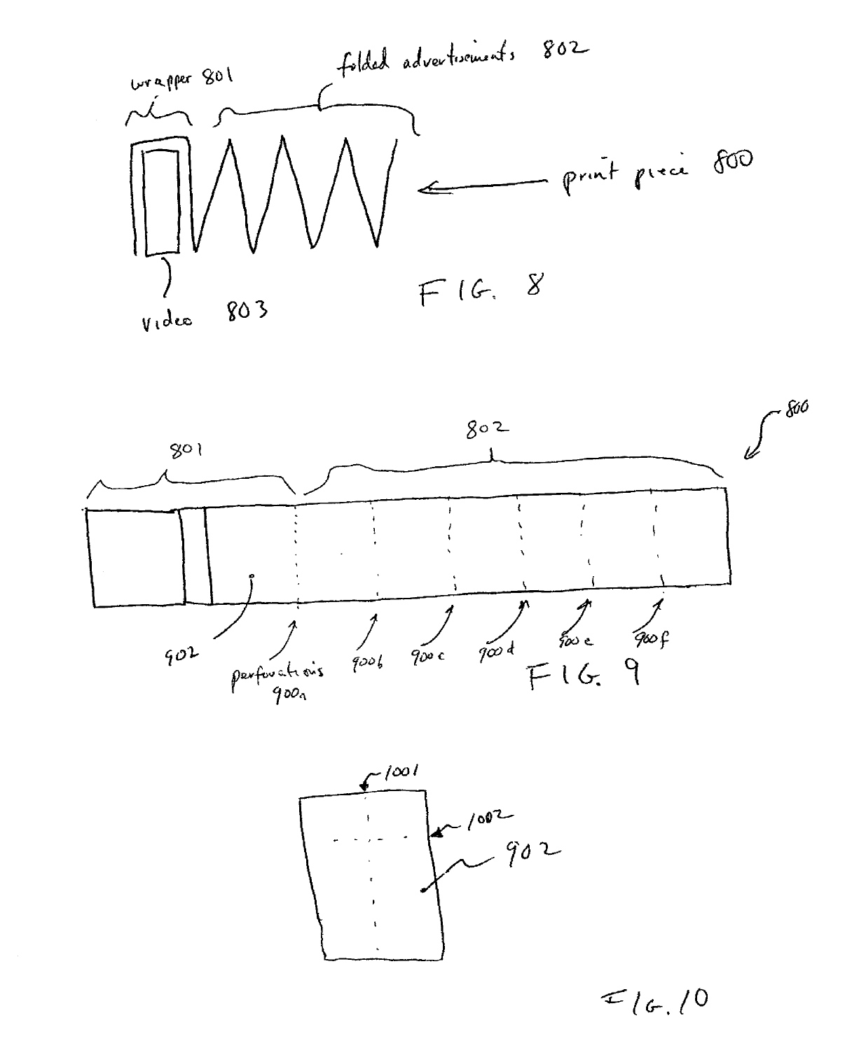

One example of a print piece is shown in FIG. 8. This example is a print piece 800 which includes a wrapper portion 801 which surrounds the video and/or its container 803 and a folded advertisement portion 802. This type of print piece 800 may be folded up against the video (and/or its container) 803 and shrink wrapped. An added dramatic effect is experienced when opening the package, as the folded advertisement may unfold quickly and reveal a plurality of colorful coupons and/or advertisements. In one embodiment the pages of the folded advertisement 802 are perforated to make individual coupons. FIG. 9 shows one example of a print piece 800 laid flat to show the wrapper portion 801 and the folded advertisement portion 802 and perforations 900a-900f. Each page 902 of the folded advertisement portion 802 may also be perforated, as demonstrated in one example shown in FIG. 10. In one embodiment, the page 902 is perforated down the middle as shown by perforation 1001 to provide multiple coupons per page. The page 902 in one embodiment is also perforated in the other direction 1002 to provide multiple coupons per page.

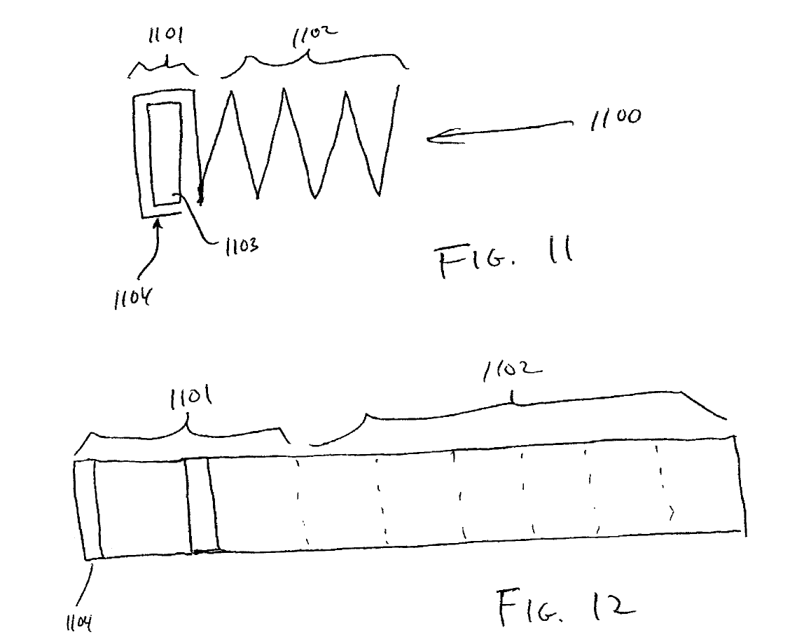

In one embodiment a print piece 1100 includes a wrapper portion 1101 having an additional flap 1104 to cover the entire video 1103, as demonstrated in FIG. 11. FIG. 12 shows the print piece 1100 laid flat to demonstrate additional flap 1104.

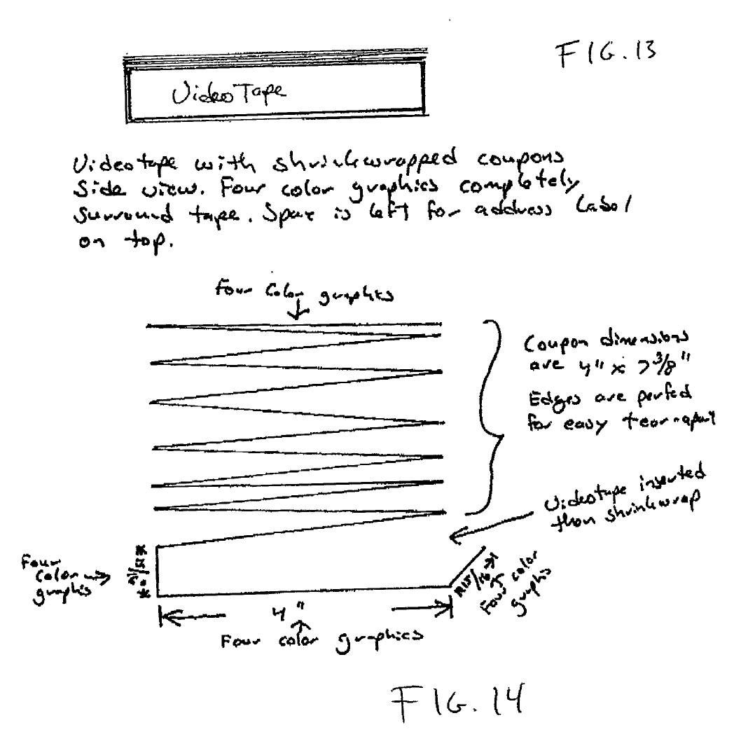

The folds are positioned to allow the wrapper to enclose the video or its container and to allow the folded advertisement to lay flat in an accordion style so that the assembly is shrink wrapped for distribution, as demonstrated by FIG. 13. Other variations are possible without departing from the scope of the present system.

It is understood that the print pieces may contain four color graphics in the wrapper portion and/or in the folded advertisement portion, as demonstrated by FIG. 14. In one embodiment, the graphics are on one side of the coupon. In one embodiment, the graphics are on both sides of each coupon. In yet another embodiment the graphics are on single sides on some portions and on double sides on other portions. Many variations are possible without departing from the scope of the present invention.

Many variations and different embodiments of the print piece are possible and upon reading and understanding the present disclosure, one skilled in the art will understand that other perforation combinations and positions may be accomplished without departing from the scope of the present system.

In alternate embodiments, the information about the drawing may be partly or wholly included in the video. In one embodiment, the video and the print piece may include instructions on how to enter a drawing or claim a prize. In one example, a code is provided which a prospective consumer can bring to a store and check to see if they have won a prize. In an alternate embodiment, a website may be provided which will ask questions of the consumer and receive the code to determine if they won a prize. The print piece works with the video to increase the probability of a sale, or at least gather some consumer information for future marketing efforts.

Packaging

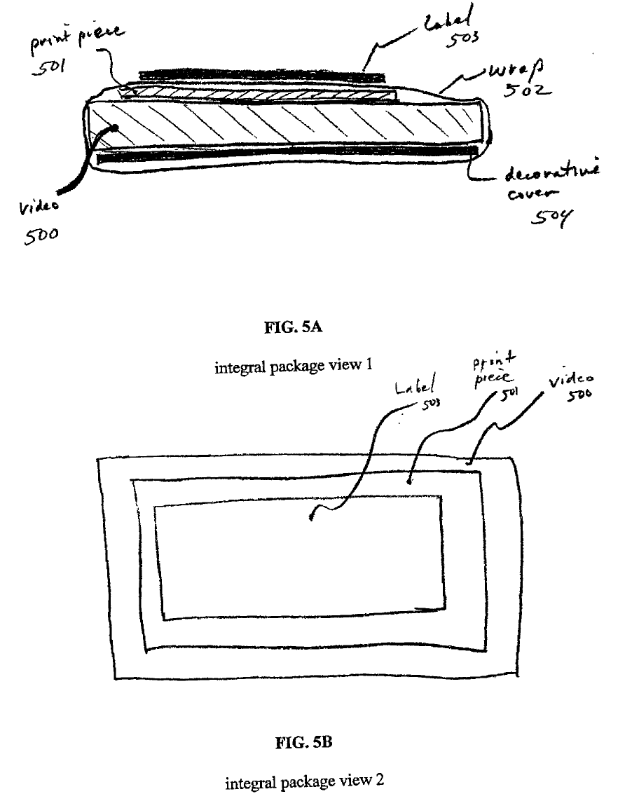

The video and print piece are packaged together 106. In one embodiment, the print piece is secured to the video using a plastic wrap. In one embodiment, the wrap is clear so that the print piece can be seen. In one embodiment, the wrap is opaque. One embodiment of the video and print piece assembly is shown in FIG. 5A. The print piece 501 is laid on video 500 and the assembly is wrapped with wrap 502. In one embodiment, a label 503 is attached to the assembly. In one embodiment, the label 503 is an adhesive. In another embodiment, the label 503 is an ink label coating the wrap 502. In yet another embodiment, the label 503 is an integral part of the wrap. In yet another embodiment, the label is attached to the print piece 501 and the wrap 502 is clear in at least the area of the label to provide visibility of the label. In yet another embodiment, the label is integral to the print piece 501 and the wrap 502 is clear in at least the area of the label to provide visibility of the label.

FIG. 5B shows placement of a label 503, print piece 501, and video according to one embodiment of the present system. In the situation where the label is a part of the print piece, the wrap is clear to show the label information.

Optional Decorative Cover

In another embodiment, an optional decorative cover 504 is assembled to a second side of the video 500. In one embodiment, the decorative cover 504 includes a mailing label. In one embodiment, the decorative cover 504 includes four color graphics. In one embodiment the decorative cover 504 includes locations for mailing information. The decorative cover 504 may be sized to approximate the size of the video 500. Distinctive colors and trademarks may be placed on the decorative cover 504.

The design of FIG. 7 may also be used on the decorative cover to facilitate delivery of the video and print piece assembly.

Distribution

The video and print piece assembly are distributed as a single package to the target consumers 107. When the recipient receives the package, they remove the wrap and the print piece is free from the video. The print piece and video work together to prompt the recipients to watch the tape and take advantage of the offers. Studies show that a recipient of a video is likely to view the video. The print piece provides additional information that the recipient can use in making a selection of goods and/or services from the partner merchants.

In one example the package is delivered to individual households via USPS (mail). Other methods of getting the piece into the hands of the targeted demographic include: Express courier such as Fed Ex, UPS, Roadrunner, etc. It is also possible that the package is delivered with the newspaper or other periodical/magazine. The tape/print piece could be delivered with other home delivery companies. Examples include Simon Delivers and Swans (groceries). The tape/print piece could be hand-delivered at the participating partner's place of business. For example, a retailer who is part of the program could have a supply of tapes on hand and give out tapes to customers not included in the targeted demographic. Other delivery systems may be used without departing from the scope of the present system.

Collection and Use of Consumer Information

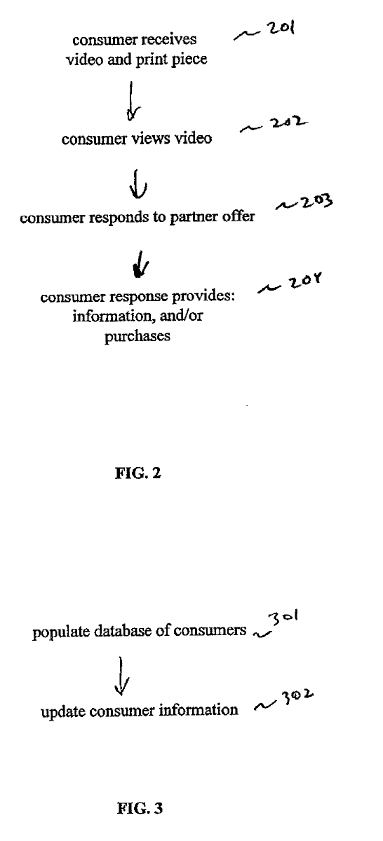

Consumer information is collected as the target consumers participate in the offers provided by the video and print piece 108. In one embodiment, demonstrated by FIG. 2, the consumer receives the video and print piece 201. The consumer then views the video 202 and if the marketing is successful, the consumer responds to one or more partner offers 203. Even if a purchase is not made, the consumer will usually provide valuable information about consumer choices 204.

Such consumer information allows the merchant partners to collect a database of information. In FIG. 3, the information about target consumers is placed in a database 301 and the information arising from the video and print piece marketing is entered into the database to update consumer information 302.

Target Consumer Information

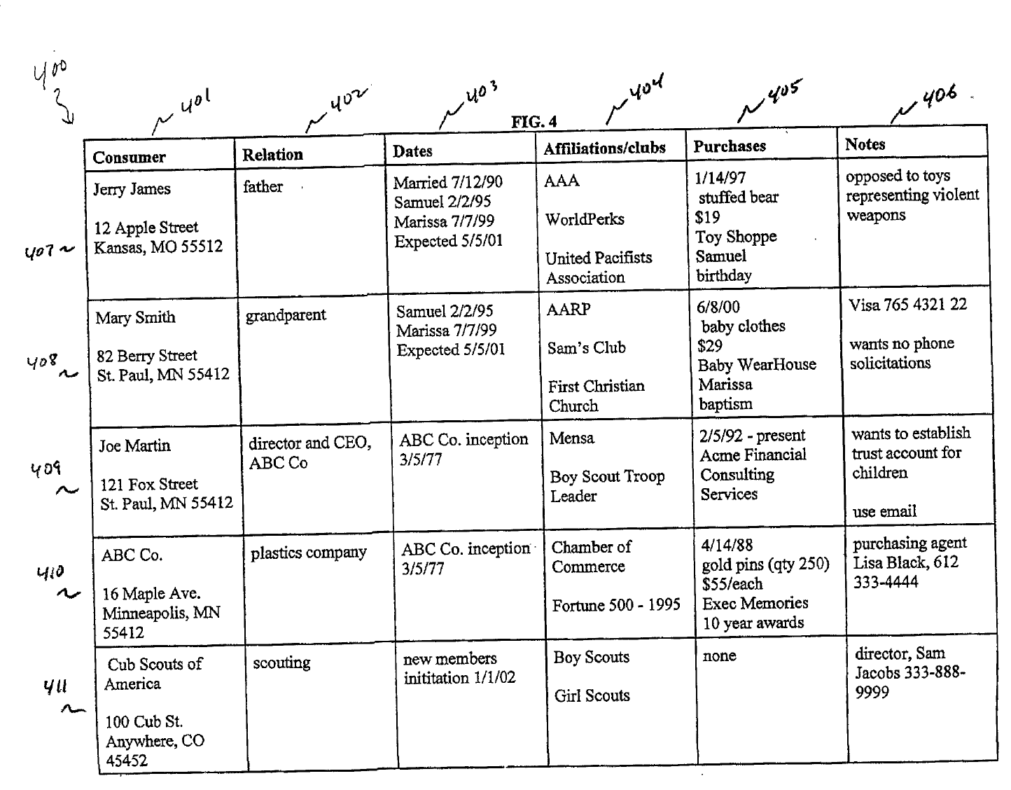

FIG. 4 demonstrates the type of information that may be used and stored by the present system. The database fields and examples herein are intended only to demonstrate the system and are not intended to be an exclusive or exhaustive teaching of one embodiment of the present system.

Using the toddler birthday example, it can be seen from the relation 402 and dates 403 fields of the database 400, that the target consumers 401 are Jerry James (father of toddlers) and Mary Smith (grandparent of toddlers). The affiliations/clubs 404 fields can be used to identify possible discounts which each target consumer can enjoy. In one embodiment of the present system, specialized coupons are printed for each target consumer which provide specialized incentives based on their affiliations/clubs 404 memberships.

In one embodiment of the present system, the purchases 405 field is used to determine what types of gifts are purchased by the target consumers to determine how to market to the target consumers. The offers may be varied, for example, depending on whether the consumer has bought substantial amounts of merchandise from partners in the past.

The notes 406 field also provides additional information for making a sale of merchandise which is tailored to a particular target consumer.

As another example, a marketing effort by a motivational speaker may target Joe Martin, ABC Co., and Cub Scouts of America as possible target consumers, since they may want to aim their marketing campaign at a larger group of persons. Thus, the database is used to provide different kinds of information based on the event and target consumer audience.

In another embodiment, a website identifies each target consumer using a code or other form of identification, and the screens which are presented to them (e.g. when investigating the offers) are modified based on information in one or more fields of database 400. This provides the system with the capability of specifically tailoring offers to each of the target consumers. For example, if a target consumer logs in who is a member of AARP (e.g., Mary Smith), then the offers to Mary Smith may include AARP discounts. Thus, the present system in various embodiments provides an adaptive marketing system for individuals and corporations as target consumers.

Those skilled in the art upon reading the foregoing will understand that other data fields and other uses may be incorporated into the system without departing from the scope of the present system.

Other Applications

The print piece described herein may be used in packaging of audio tapes and hardcover and soft-cover books. The audio tapes and books may also be labeled and delivered as provided herein. The audio tapes and books may be marketed using the teachings provided herein. It is understood that other uses for the print piece, packaging and distribution exist which are within the scope of the present system.

Example Uses of the System

The system can be used as a direct mail marketing tool. The starting point for each video concept is a life event such as the birth of a baby, getting married, moving into a new home, retirement, or even a special holiday like Christmas. Once the life event is selected, a coordinator investigates and purchases targeted mail lists of people experiencing the life event. The coordinator then lists all the possible companies who want to reach people experiencing the life event. These companies are asked to participate in a bundled direct mail video program. When a number of partners agree to be part of the bundled video program, then coordinator produces the video program featuring each of the companies, adds a print coupon (offer) to the tape and mails to the targeted life event list. In addition, at the beginning of each new life event video, research is done on a telemarketing basis to verify receipt of the video and to determine viewer acceptance. The benefits to participating companies are:

A) Multiple messages (video and print) in one direct mail piece allows for increased viewer acceptance

B) Use of video increases retention of messages

C) Direct Mail video will get watched instead of thrown away

D) Partnering with other non-competing companies significantly decreases cost

E) Partnering with other non-competing companies enhances image of each partner (the tide rises all boats)

F) Video messages have higher response rates than print messages

G) Targeting life events assures ready to purchase prospects

H) Additional information that is not company specific adds value and increases watch ability of the program.

Components of Each Video:

1) Life Event Theme:

Life event themes are selected on the basis of the number of dollars spent on the life event, multiple companies that want to target that audience, access to proprietary mail list of people experiencing the life event, and the determination that a significant number of people to warrant a mailing are experiencing the life event. Once the theme is selected, scripting and story boarding will commence leaving spaces for individual partner participation.

2) Selling Process:

Once step 1 is complete, the coordinator then begins the selling process to find a sufficient number of partners to participate in the individual program. It is important for each theme to have one or two lead companies commit first. This makes it easier for other smaller companies to commit as well. Once a number of companies commit to a program, the coordinator will begin the print and video production phase of the program. Depending on the life event theme, the coordinator may have two to eight video partners on each program. For the print part of the mailing, the coordinator will solicit two to twelve partners.

3) List Acquisition:

At the time that the partners commit to an individual program, the coordinator will purchase the mail list of the life event customers within the geographic area to be mailed. Each mail list obtained by the coordinator will be verified for accuracy and timeliness of the data.

4) Video Production:

The production of the direct mail video will be done with the highest industry standards and with the best digital equipment (shooting and editing) available today. Based on the life event theme, the coordinator will select the best scriptwriter and best on camera talent for the target demographic. In addition, an expert in each life event area will be chosen to provide information and tips that will add value to the production. For example, in the New Homeowner Program, an expert in organizing your home could be selected to provide information on how to get rid of that cluttered look. In the Help Wanted Program an industry expert in training people for job interviews could provide useful tips on making a good first impression. Each partners segment must be approved in writing prior to the development of the master tape. Once the master tape is approved and completed, it will go to a videotape duplicator selected by the coordinator.

5) Print Production Offers:

Once companies are selected and have committed to a program, the coordinator will work with them to create and design the most attractive and profitable print offers. The coordinator will graphically develop these offers, and each company participating must approve verbally and in writing all graphic design. Once all partners have approved print graphics, the coordinator will select and contract with a printer to create these bundled offers. Once the print run is complete, the printer will deliver the printed pieces to the videotape duplicator for shrink-wrapping with the videotape.

6) Print Production Tape Label:

The videotapes selected by the coordinator were selected not only for a lighter weight to keep postage costs down, but also for increased size of the face label allowing for dramatic four color graphics. With each program, the coordinator will contract will a graphic design house to create the best possible four color graphics that go on the face of the videotape. Once the label design has been completed and approved, a print vendor will selected to produce the labels. Labels will then be sent to the duplicator for application to the videotapes.

7) Manufacturing Process:

The videotape duplicator selected by the coordinator will be responsible for the following:

a) Duplication of the master tape

b) Quality Control on each duplicated tape

c) Application of the full-face tape label

d) Addition of the print offer piece to the videotape

e) Shrink-wrapping of the tape and print piece

f) Application of the address label

g) Delivery to the post office or other facility for distribution to the home

8) Research:

Within two or more weeks of an initial mailing the coordinator will contract with a telemarketing research company to call a select number of household that received the video mailing. This research firm will verify receipt of the tape, consumer acceptance levels, and anticipated usage of the offers.

Mail Video Description:

A unique method of presenting multiple information and messages from multiple companies to a targeted demographic audience is presented. This method includes mailing a lightweight videocassette of not more than 20 minutes in length to individual households. On the cassette are messages of 2 to 3 minutes in length from 4 to 8 non-competing companies. In addition, these companies also enclose print coupon offer referencing what was seen on the videotape. These print coupons are put on one sheet and perffed so that the consumer can easily tear them apart for usage. This coupon sheet is folded to the same length and width of the videocassette. The print piece has a blank area for the address label to be attached, and includes the bulk mail stamp as well. This print piece is shrink-wrapped to the videocassette so that when the shrink-wrap is removed from the tape, the coupon sheet falls out. When the consumer receives the videotape in the mail, it immediate stands our from all other direct mail pieces. On one face of the tape is seen the address label with bulk mail stamp. On the opposite side is an attractive four-color full-face label identifying the program and prompting the viewer to watch the video. In addition on the spine label of the video will be additional information prompting the consumer to put the cassette in the VCR and watch. As the videotape duplication industry has begun to look at video direct mail as a viable option, they have created lighter weight V-O's (the plastic portion of the videotape) to keep mailing costs down. Some of the more popular lightweight videotapes are the Global Zero, the Intellishell, the Featherweight cassette, and the Mail-rite cassette.

Additional Features of the Partners Direct Videos:

As more and more direct mail video programs are prepared; they will test various methods of getting the consumer to watch the tape. These will usually take the place of contests where if the consumer gets the winning video a prize or money will be awarded. There are various ways of doing these contests. These include:

1) Simply editing onto a limited number of cassettes the words “YOU WIN”. If a consumer gets one of these tapes, they will be instructed to call the coordinator's office(s) and claim their prize. Outside graphics will also instruct the consumer that certain tapes might contain prizes.

2) An additional way of getting the consumer to respond to us that would also help us in tracking, would be to assign to each tape a number. The consumer is then directed to our Web Site to see if they have a winning cassette or not. Even if they don't have a winning number they will be instructed to give us their names and addresses for a drawing for additional prizes.

3) Individual companies could do their own contests using a proprietary number system. For example a retail store could direct the viewer to take the tape back to the store, and if numbers match, the viewer wins a prize.

4) A proprietary number system could be included on the print portion of the program, edited onto the video portion of the tape, put on the audio portion of the video, or inserted into the V-O itself.

Some Recurring Life Event Themes:

1) Birthday Club

2) Baby Club

3) New Homeowner Club

4) New Mover Club

5) New Renter Club

6) The Home Re-Modeling Club

7) The Making Your Home Look New Again Club

8) The New Car Club

9) The Used Car Club

10) The Sweet Sixteen Birthday Club

11) The Graduation Club

12) The Upcoming Wedding club

13) The Wedding Club

14) The Going Away To College Club

15) Making the Right College Choices Club

16) The Help Wanted Club

17) The Hot Jobs Club

18) The Energy Conservation Club

19) Making Mom's Life More Convenient Club

20) The Summer Fun Club

21) The Holiday Helper Club

22) The Convenient Shopping Club

23) The New Toys For Kids Club

24) The Fishing Opener Club

25) The Duck Hunting Club

26) The Deer Hunting Club

27) The Ice Fishing Club

28) The Retired and Loving It Club

29) The Financial Security Club

30) The Preparing to Die Club (Only Kidding)

31) The Getting Your Child Financially Ready For College Club

32) The Hot Summer Toys Club

33) The Hot Summer Toys for Big Kids Club

34) The Cabin Fever Get Away Club

35) The Mom I'm Bored Club

It is understood that the examples provided here are intended to demonstrate the present system, and are not intended in an exclusive or exhaustive sense. In varying embodiments, the steps may differ in detail and order without departing from the scope of the present system. It is also understood that in embodiments some of the process steps may be done in an iterative fashion or with in a nonlinear approach without departing from the scope of the present system.

This detailed description is intended to provide details on how to make and use the present invention, including a best mode of the invention. The embodiments provided herein may differ in electrical, mechanical, and chemical nature without departing from the scope of the present invention. It is understood that some organizational variation in the embodiments of apparatus and method provided herein may fall within the scope of the present invention, which is provided by the appended claims and equivalents thereto.

What is claimed is:

1. A method, comprising:
producing a video and a print piece including one or more offers from a plurality of partners, the one or more offers based on a prospective event common to a plurality of target consumers; and
distributing the video and the print piece as an integrated package to the plurality of target consumers.

2. The method of claim 1, wherein the prospective event is a birthday.

3. The method of claim 1, wherein the prospective event is a graduation.

4. The method of claim 1, wherein the prospective event is an anniversary.

5. The method of claim 1, wherein the prospective event is a religious event.

6. The method of claim 1, wherein the prospective event is a birth of a child.

7. The method of claim 1, wherein the prospective event is a purchase of a home.

8. The method of claim 1, wherein the prospective event is a purchase of an automobile.

9. The method of claim 1, wherein the prospective event is seeking a new job.

10. The method of claim 1, wherein the prospective event is an upcoming holiday.

11. The method of claim 1, wherein the prospective event is a retirement.

12. The method of claim 1, wherein the prospective event is a celebration.

13. The method of claim 1, further comprising shrink wrapping the integrated package.

14. The method of claim 1, further comprising storing the video on magnetic tape.

15. The method of claim 1, further comprising storing the video on a digital video disk.

16. The method of claim 1, further comprising storing the video on a compact disk.

17. The method of claim 1, wherein the print piece includes a coupon.

18. The method of claim 1, wherein the print piece includes a code.

19. The method of claim 1, wherein the video includes a code.

20. The method of claim 1, wherein the plurality of target consumers is invited to make a purchase from one or more of the plurality of partners.

21. The method of claim 1, wherein the plurality of target consumers is invited to visit a partner's business.

22. The method of claim 21, wherein the partner's business includes a store.

23. The method of claim 21, wherein the partner's business includes a website.

24. The method of claim 1, wherein the plurality of target consumers is invited to claim a prize.

25. The method of claim 1, wherein the plurality of target consumers is directed to a website to claim a prize.

26. An apparatus, comprising:
a video including one or more offers from a plurality of partners for a plurality of target consumers selected based on a future event;
a print piece including information on participation in the one or more offers; and
a label;
wherein the video, the print piece, and the label are assembled for delivery to each of the plurality of target consumers.

27. The apparatus of claim 26, wherein the video is stored on a magnetic tape.

28. The apparatus of claim 26, wherein the video is stored on a digital video disk.

29. The apparatus of claim 26, wherein the video is stored on a compact disk.

30. The apparatus of claim 26, wherein the print piece includes a plurality of coupons.

31. The apparatus of claim 26, wherein the print piece includes a code.

32. The apparatus of claim 26, wherein the video includes a code.

33. The apparatus of claim 26, wherein the video includes a second label on a first side and wherein the print piece is placed on a second side and the video and the print piece are shrink wrapped and the label is placed on the shrink wrap for distribution.

34. The apparatus of claim 33, wherein the shrink wrap is clear to provide visibility of the second label.

35. The apparatus of claim 33, wherein the shrink wrap is opaque.

36. A method comprising:
compiling a list of a plurality of target consumers;
producing a video including offers from a plurality of partners for an upcoming event common to the plurality of target consumers, such as a birthday or an anniversary;
generating a print piece providing coupons for redemption by each consumer of the plurality of target consumers;
generating a label for each consumer of the plurality of target consumers; and
packaging the print piece, the video and the label for distribution to the plurality of target consumers as an integrated package.

37. The method of claim 36, wherein the coupons are adjusted based on information about a particular consumer of the plurality of target consumers.

38. The method of claim 36, further comprising distributing the integrated package to each of the plurality of target consumers.

39. The method of claim 38, further comprising updating a database with consumer selection information from each target consumer responding to the offers.

40. The method of claim 38, wherein a consumer enters a code into a website and wherein the consumer is identified by the code.

41. The method of claim 40, wherein the website adjusts offers made to the consumer based on information in a database.

42. A method, comprising:
participating in generation of a video including one or more offers from a plurality of partners, the one or more offers based on a prospective event;
participating in generation of a print piece related to the one or more offers;
participating in packaging of the video with the print piece to create a plurality of packages; and
participating in distribution of the plurality of packages to a plurality of target consumers, the target consumers identified based on the prospective event.
